(19) United States
(12) Patent Application Publication
(10) Pub. No.: US 2017/0220363 A1
(43) Pub. Date: Aug. 3, 2017

(54) Mainframe system tape image data exchange between mainframe emulator system

(71) Applicant: Paul Francis Gorlinsky, Ellenton, FL (US)

(72) Inventor: Paul Francis Gorlinsky, Ellenton, FL (US)

(21) Appl. No.: 15/416,172

(22) Filed: Jan. 26, 2017

Related U.S. Application Data
(60) Provisional application No. 62/288,205, filed on Jan. 28, 2016.

(51) Int. Cl. G06F 9/455; G06F 13/10; H04L 29/06; G06F 3/06; G06F 3/12

(52) U.S. Cl. CPC G06F 9/4552; G06F 3/0664; G06F 3/1209; H04L 29/06; G06F 13/105; G06F 3/0682; G11B 2220/45

(57) ABSTRACT

This invention provides a method of solving the technological challenges with the rapid exchange of information between IBM mainframe computers and compatibles mainframe computers (Mainframe) and an emulated mainframe environment, usually hosted on other types of computer hardware, notably on low-cost personal computers, such as IBM's zPDT or the Hercules open-source emulator module (MF-Emulator). The invention will allow Mainframe's data to be exchanged with a MF-Emulator in a method compatible with both environments. The invention provides a virtual tape device apparatus attached directly to the Mainframes's input/output (I/O) channel interface and it provides a network (TCP/IP) attached interface to the MF-Emulator module hosting computer. Data is then written to or read from a Tape Image Data file that is used by the virtual tape device provided by the invention and by the MF-Emulator emulator module. No conversion of the data character set is necessary. The invention provides a secure, fast exchange of data greatly reducing the amount of time and resources necessary to exchange the data.

### TECHNICAL FIELD

The present invention relates to a virtual tape apparatus and method of exchanging data used by Mainframe computers and Mainframe emulators.

### BACKGROUND ART

In general, Mainframe computer systems have been used to process data within all sizes of corporations and government institutions where centralized computing was either a necessity or desire.

The term, Mainframe system, is a computer industry term indicating a multi-user, a multi-function large-scale computer originally designed and manufactured by a large company e.g. IBM Corporation. Mainframe systems are engineered to perform computations required for the enterprise business activities of companies, like small and large corporations, across multiple commercial and governmental environments, and are configured in a manner to provide centralization of computer functions rather than distributed.

The overall cost of such Mainframe systems has been increasing and as a result, emulation of the Mainframe environment on less expensive computers evolved to reduce software development life-cycle costs. The MF-Emulator is a product like the IBM zPDT or the open-system Hercules product emulator modules and they are usually hosted on a less expensive computer/operating system such as a low-cost personal computer running the LINUX, Microsoft Windows, Apple Mac OS X, etc., operating systems. The MF-Emulator product emulates the Mainframe computer, disk system H/W, network interface H/W, tape system H/W and terminal H/W. The operating systems running of the Mainframe are the same as the ones available for MF-Emulator. As a result of MF-Emulator being an emulator module without “real” Mainframe hardware attachments, the exchange of data, including program source files and test data, etc., is often time consuming, labor intensive and not secure.

### CURRENT METHOD

IBM operating systems are both interactive and batch oriented. The exchange activities between the Mainframe and MF-Emulator usually involve large amounts of data. Using FIG. 3 as a reference, the following steps are needed:
(a) A batch job on the Mainframe 3.100 creates a sequential file dataset of the selected data 3.110 on a work disk 3.120.
(b) A network file transfer program, most notably FTP and SFTP, is then used to read and transmit the dataset on the work disk 3.120 across the network 3.200 from the source machine 3.100 to the target MF-Emulator machine 3.300 work disk 3.320.
(c) A batch job on MF-Emulator 3.330 reads the sequential file dataset on the work disk 3.320 and creates a copy of the data on the target disk 3.310.

Network file transfer programs like FTP require end-to-end software verification of the packets sent being transmitted, as a result, FTP latency (overhead) is extremely large. Network file transfer programs are also a very computer resource intensive on the Mainframe. The method of using a network file transfer program like FTP, requires several read and/or write passes across the data being exchanged there by, consuming time and computer resources.

Using FIG. 2 as a reference, the following detail the current method being used:
(d) Source Disk 2.100 is read by a utility disk dump program 2.105 which writes a sequential file dataset on the work disk 2.110. First pass Read Source data, second pass Write data.
(e) Network file transfer program client 2.130 then reads the sequential file dataset on work disk 2.120 and transmits the data to a file transfer program server (2.200) on the target system. Third pass Read data, fourth pass transmit data .
(f) The network file transfer program server 2.200 receives the data and writes the sequential file dataset to a work disk 2.210 on the target system. Fifth pass receive data, sixth pass write data.
(g) The sequential file dataset on the work disk 2.210 is then read by a utility disk restore program 2.225 and writes the Target Disk 2.230. Seventh pass read data. Eight pass write Target Data.

Eight (8) passes are made of the data along with the overhead and latencies of transmitting the data using a network file transfer program, most notably FTP and SFTP.

The Source and Target system are either paired as a Mainframe sending to a MF-Emulator, or as a MF-Emulator sending to a Mainframe.

The current method is time consuming and operationally expensive.

### DISCLOSURE OF INVENTION

### Technical Problem

The present invention is directed to a virtual tape apparatus and method of exchanging data between the Mainframe and MF-Emulator that minimizes the time and the cost necessary to complete the exchange. It is a two (2) step process consist of reading the source data and writing the tape image file, and reading the tape image file and writing the target data.

### Technical Solution

The present invention provides a virtual tape apparatus and method that connects directly to the Mainframe's I/O channel H/W using a very high speed connection like, but not limited to, a Fibre Channel incorporating the NCITS FC-SB⁽⁸⁾ protocols. The apparatus' virtual tape method emulates current Mainframe tape drives, most notably IBM 3480⁽⁴⁾, 3490E⁽⁵⁾ or 3590⁽⁶⁾ tape devices, which are supported by the Mainframe operating system. The apparatus creates a tape image file in a file storage pool designated by the user when configuring the apparatus. This pool is shared with the MF-Emulator hosted PC.

### Advantageous Effects

According to the inventive virtual tape apparatus and method for exchanging data between the Mainframe and MF-Emulator, it is possible to minimize the time, expense and effort necessary to exchange the data necessary to reduce software development life-cycle overall costs.

### BRIEF DESCRIPTION OF THE DRAWINGS

FIG. 1 is a block diagram schematically illustrating a virtual tape data apparatus for exchanging Mainframe and MF-Emulator data according to an exemplary embodiment of the present invention; and

FIG. 2 is a block diagram schematically illustrating details of the current method used to exchange Mainframe and MF-Emulator data; and

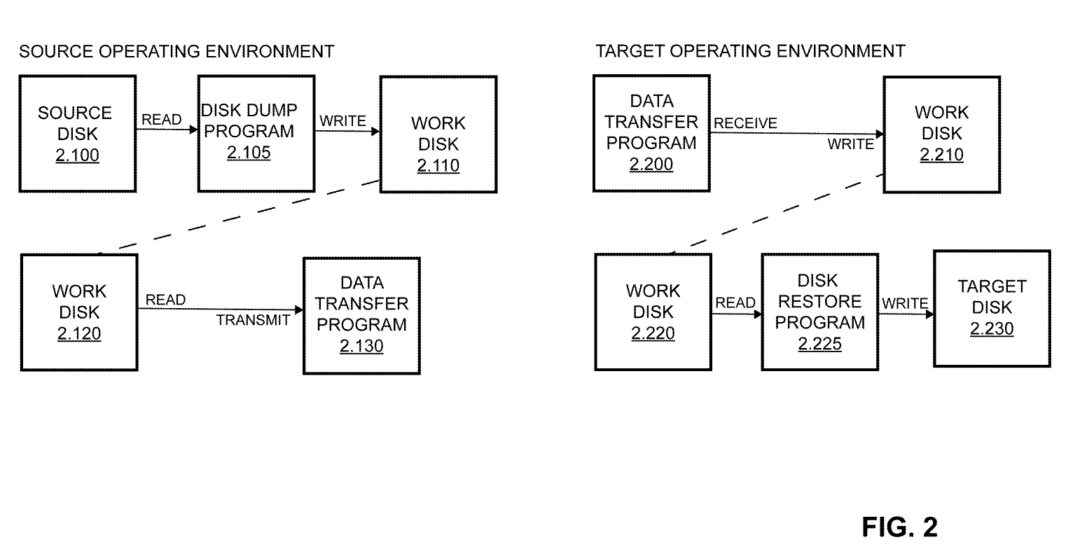

FIG. 3 is a block diagram schematically illustrating general flow of the current method used to exchange Mainframe and MF-Emulator data.

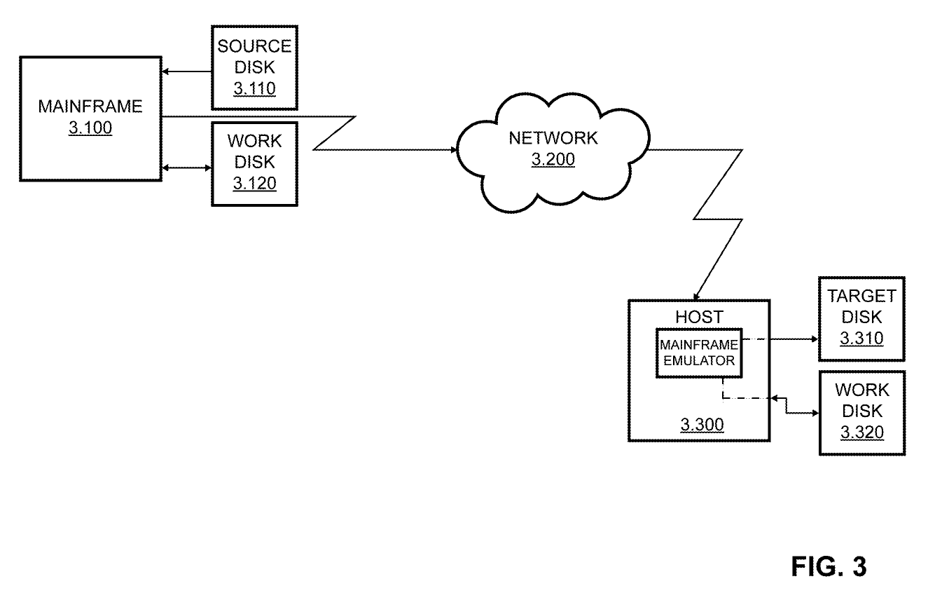

### LIST OF COMPONENT NUMERALS

100 Mainframe computer using an IBM supplied operating system, most notably, IBM z/OS, zNSE or zNM
200 Virtual tape data apparatus
300 Network, like the Internet, internal corporate or user network
400 Mainframe emulator module (MF-Emulator) running an IBM operating system, most notably, z/OS, zNSE or zNM
2.100 Source Operating Environmen—Source Disk
2.105 Source Operating Environment—Disk/data Dump program module
2.110 Source Operating Environment—Work Disk
2.120 Source Operating Environment—Work Disk (same instance as 2.110)
2.130 Source Operating Environment—Data transfer program module (sender)
2.220 Target Operating Environment—Data transfer program module (receiver)
2.210 Target Operating Environment—Work Disk
2.220 Target Operating Environment—Work Disk (same instance as 2.210)
2.225 Target Operating Environment—Disk/data Restore program module
2.230 Target Operating Environment—Target Disk
3.100 Mainframe computer (like component 100)
3.110 Source computer source of data
3.120 Source computer work disk space
3.200 Network
3.300 Computer Host with MF-Emulator Mainframe emulation module (like component 400)
3.310 Target computer target disk for data used by MF-Emulator
3.320 Target computer work disk space used by MF-Emulator

### MODE FOR THE INVENTION

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

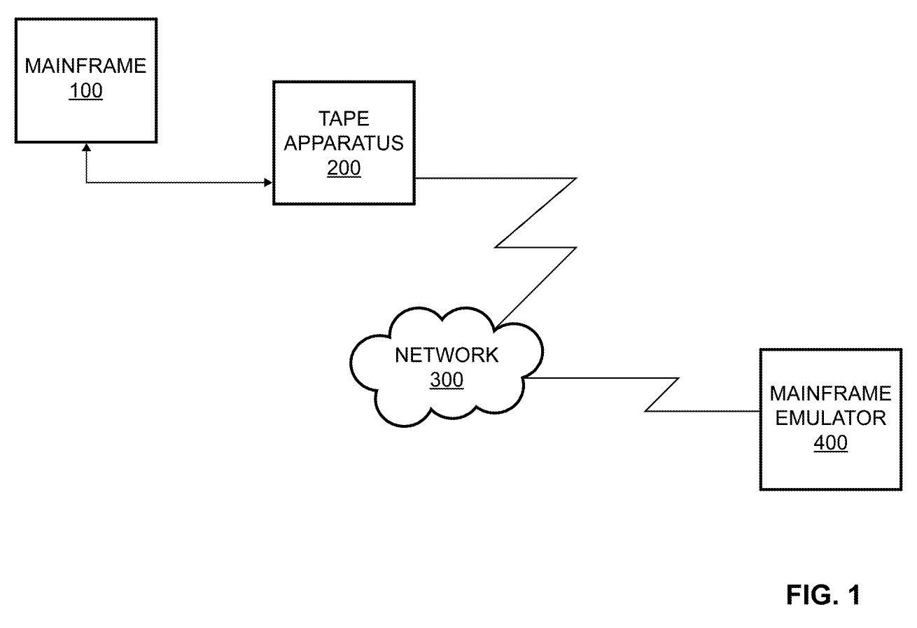

FIG. 1 is a block diagram schematically illustrating a virtual tape data apparatus for exchanging Mainframe and MF-Emulator data according to an exemplary embodiment of the present invention.

Referring to FIG. 1, a virtual tape data apparatus 200 that exchanges data between the Mainframe 100 and MF-Emulator Mainframe emulator 400.

Here, the Mainframe system 100 is a computer industry term indicating a multi-user, a multi-function large-scale computer originally designed and manufactured by a large company e.g. IBM Corporation. Mainframe systems are engineered to perform computations required for the enterprise business activities of companies small and large, and across multiple commercial and governmental environments, and are configured in a manner to provide centralization of computer functions rather than distributed.

The virtual tape data apparatus 200 is computer system hosting the virtual tape emulation module. The computer is usually a small, commodity computer system. The term “commodity computer system” is an industrial terminology indicating a method for enabling hardware (H/W) and software (S/W) of different computer manufacturing companies to be linked together and is capable of being classified according to operating system, hosted applications or systems, and so on. The computer system 200 mentioned here is a small to medium-scale computer having an operating system, e.g., Linux, Windows, or so on. The computer system also contains one (1) or more channel adapter cards to provide physical connection to the Mainframe I/O channel for data communications, and one (1) or more network adapter cards providing connectivity the network.

The cloud image labeled NETWORK 300 represents any network capable of providing a data connection between one or more computers, i.e., the Network. The virtual tape data apparatus 200 and the MF-Emulator Mainframe emulator 400 are each connected to the Network to provide a common or shared data storage apparatus as a tape image data file storage repository.

Meanwhile, the MF-Emulator Mainframe emulator module 400 is hosted on a computer, notably an open system, commodity personal or server computer. The open system, commodity personal or server computer is industrial terminology indicating a method for enabling hardware (H/W) and software (S/W) of different computer manufacturing companies to be linked together and is capable of being classified according to operating system, hosted applications or systems, and so on. The computer system 400 mentioned here is most notably, a small to medium-scale computer having an operating system, e.g., Linux, Unix, Windows, or so on.

The data exchange module is located on the virtual tape data apparatus 200 and functions to provide virtual tape emulation, emulating current Mainframe supported tape drives, most notably the IBM 3480, 3490E or 3590 tape devices, and tape image data repository management.

The tape image data repository is a data storage apparatus that is shared between the MF-Emulator system 400 hosting the Mainframe emulator module and the virtual tape data apparatus 200 hosting the data exchange module. The tape image data is in a format common to the Mainframe emulator 400 and the virtual tape data apparatus 200.

Referring to FIG. 1, a batch job that reads a source disk attached to the Mainframe 100, writes the extracted data to a virtual tape emulated device created by data exchange module located on the virtual tape data apparatus 200 that is connected to the Mainframe 100. When the batch job completes, a tape image data file is deposited with in the data repository that is shared between the virtual tape data apparatus 200 and the MF-Emulator Mainframe emulator 400 using a Network connection 300. A batch job is now executed on the MF-Emulator Mainframe emulator operating system, reading the tape image data file and writing to the target disk available to the MF-Emulator Mainframe emulator 400.

In addition, the entire process can be reversed with the MF-Emulator 400 being the source of the data and the Mainframe 100 being the target.

Therefore, the entire transfer process, source disk information to target disk information, can be accomplished with two (2) batch jobs, with just four (4) read or write passes of the data, instead of the eight (8) read or write passes previously described as “Current Method”, resulting in a fifty percent (50%) reduction in the amount of data read and/or written and the elimination of network file transfer program latency.

While the invention has been shown and described with reference to certain exemplary embodiments of a data exchange apparatus and method for exchanging data between Mainframes and MF-Emulator Mainframe emulator, it will be understood by those skilled in the art that various changes in form and details may be made therein without departing from the spirit and scope of the invention as defined by the appended claims.

### CLASSIFICATIONS

U.S. Classification 703/24, 703/25, 703/27, 707/821, 710/62, 710/65, 717/124

International Classification G06F17/30

### NON-PATENT CITATIONS

1. IBM System z Personal Development Tool—IBM Corporation—ZSQ03041-USEN-00 (2012)
2. http://hercules-390.eu—The Hercules System/370, ESA/390, and z/Architecture Emulator
3. https://en.wikipedia.org/wiki/Hercules_(emulator) Wikipedia—Hercules (emulator)
4. IBM 3480 Magnetic Tape Subsystem—Introduction—IBM Corporation—GA32-0041 (1986)
5. IBM 3490E Tape Subsystem Models F00, F01, F11, F1A Hardware Reference—IBM Corporation—GA32-0379
6. IBM 3590 High Performance Tape Subsystem Hardware Reference—IBM Corporation—GA32-0331
7. IBM z/Architecture Principles of Operation—IBM Corporation—SA22-7832 (2015)
8. Fibre Channel—Single-Byte Command Code Sets Mapping Protocol—American National Standard of Accredited Standards Committee (NCITS), American National Standards Institute—INCITS 485 (2014)

### TRADEMARK INFORMATION

IBM, z/OS, z/VM, OS/390 and zPDT are registered trademarks of IBM Corporation

1. A data exchange apparatus for the exchanging of data between a Mainframe and a Mainframe emulator module hosted on an another type of computer hardware than a mainframe, the data exchange apparatus comprising:
A computer system comprising at least one processor, at least one Mainframe input/output interface card, at least one network interface card, and at least one computer-readable medium, the computer-readable medium comprising:
a data exchange module (software) connected to a Mainframe via the mainframe interface card, providing tape drive emulation recognized by the Mainframe operating system, and connected to an another computer hosting the Mainframe emulator module via a network interface card to share a least one computer-readable medium or data storage apparatus for the storage and retrieval of tape image data files, for the exchange of data between the Mainframe and the Mainframe emulator module;
transfer of the selected data stored on the source Mainframe/Mainframe emulator module to the target Mainframe/Mainframe emulator module target/destination data store;
wherein the data exchange module are external to both the Mainframe and the Mainframe emulator module;

2. A data exchange method of copying data from the source Mainframe or Mainframe emulator module to a target Mainframe or Mainframe emulator, the data exchange method comprising the steps of:
(a) connecting apparatus to the Mainframe with an input/output connection;
(b) connecting apparatus to the network;
(c) establish shared data storage using the apparatus's computer-readable medium or a data storage apparatus, connection with the Mainframe emulator hosting computer using the network;
(d) when the source computer is a Mainframe;
(d)(1) extract data from the Mainframe using tape emulation function within the data exchange module;
(d)(2) generate a tape image data file stored on the established shared data storage;
(d)(3) read the tape image data file using the Mainframe emulator modules tape emulation;
(e) when the source is the Mainframe emulator module;
(e)(1) extract data from the Mainframe emulator module using Mainframe emulator module's tape emulation;
(e)(2) generate a tape image data file stored on the established shared data storage;
(e)(3) read the extracted data on the Mainframe using tape emulation function within the data exchange module;
